(19) United States
(12) Patent Application Publication
(10) Pub. No.: US 2001/0011248 A1
(43) Pub. Date: Aug. 2, 2001

(54) METHOD AND APPARATUS FOR TRANSMITTING AND TENDERING ELECTRONIC CASH USING A PHONE WALLET

(76) Inventors: MARIA AZUA HIMMEL, AUSTIN, TX (US); HERMAN RODRIGUEZ, AUSTIN, TX (US)

Correspondence Address: DUKE W YEE, P O BOX 802334, DALLAS, TX, 75380

(21) Appl. No.: 09/240,958

(22) Filed: Jan. 29, 1999

(51) Int. Cl. G06F 17/60

(52) U.S. Cl. 705/39; 705/41; 235/383

(57) ABSTRACT

A method in a communications system for transferring cash is provided. The cash is sent in an electronic form to a phone. The cash may be requested from a financial institution using a cash transfer request. The phone stores the electronic cash for use in purchasing goods and services from a merchant. The cash is transferred to a merchant by calling a Payment Access Number.

### CROSS-REFERENCE TO RELATED APPLICATIONS

The present application is related to Application Serial Number (Attorney Docket Number AT9-98-914), filed (concurrently herewith), titled “Method and Apparatus for Using Electronic Documents Within a Smart Phone,” herein incorporated by reference.

### BACKGROUND OF THE INVENTION

1. Technical Field

The present invention relates generally to an improved data processing system and, in particular, to an improved method and apparatus for providing data in a distributed data processing system. Still more particularly, the present invention relates to a method and apparatus for transmitting and tendering electronic cash.

2. Description of Related Art

The use of computers has become more and more pervasive in society. This pervasiveness includes the integration of personal computer technology into phones. By utilizing computer technology, users or callers have access to computing functions and resources in a personal, portable device. In addition, it is envisioned that phone users would be able to use some of the same software elements in a phone that are used at home or in the office. Various applications have been developed and are being developed for use in phones. These applications generally include communication applications to help a user stay in touch with other persons at home or in the office, such as voice mail, e-mail, or two-way paging with short text messages. Some phones incorporate so-called personal information manager (PIM) technology, such as an address book or a calendar for scheduling personal events. PIMs on a phone, on a home PC, and on an office PC may be synchronized to keep all information consistent and current.

Another adopted computer technology for use on a phone is voice and speech recognition. Voice recognition technology is already well developed in multimedia desktop personal computers and, when incorporated into a phones allows a phone user to easily control and interact with a telephone application, such as automatically dialing a phone number, while obviating the need for manual input. Phones are becoming so ubiquitous that many people carry their phones so that they have some means for being in constant communication contact with others. Examples of common use of portable phones include carrying and using a phone within an automobile or possibly carrying the phone while shopping in a mall.

Historically, merchants have created flexible, portable, payment schemes for their customers, such as traditional credit cards, debit cards, and automated teller machine (ATM) cards. As a greater percentage of the population becomes “wired” with portable and computer-based communications, electronically-savvy customers demand even less encumbering methods of carrying monetary value. Phone cards, in essence, are a type of money with value for only a single particular use, i.e., obtaining long-distance telephone calls. Although convenient in certain circumstances, phone cards do not provide a flexible, pervasive monetary system.

An attempt has been made recently to use smart cards as a depository for electronic cash. A smart card is generally a small circuit board with built-in logic, firmware, and storage that provides the smart card with some kind of independent decision-making ability. Typically, a smart card is a credit-card-sized device that contains integrated circuits with limited amounts of “intelligence”.

Smart cards are expected to be used as personal identification devices in a wide range of applications and hardware devices. In such an environment, it would be unnecessary to have a separate smart card for every particular application or hardware device. In such an environment, a single smart card could be used to identify a specific user and to provide user identification for a variety of devices. A user may insert a smart card containing personal information into a smart card reader or device that interfaces with a larger computing system.

By storing wallet software on a smart card, it has been envisioned that an owner of a smart card would possess an easily transportable physical device containing several abilities, e.g., a replacement for cash and credit cards. It would be favorable to have a method of obtaining cash that is more convenient than using an ATM.

Therefore, it would be advantageous to have an improved method and apparatus for storing, sending, and tendering electronic cash using a currently existing technology, such as phones.

### SUMMARY OF THE INVENTION

The present invention provides a method and system for transferring cash in a communications system. The cash is sent in an electronic form to a phone. The cash may be requested from a financial institution using a cash transfer request. The phone stores the electronic cash for use in purchasing goods and services from a merchant. The cash is transferred to a merchant by calling a Payment Access Number.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a computing system in accordance with a preferred embodiment of the present invention;

FIG. 2 is a block diagram of a data processing system, which may be implemented as a server, in accordance with a preferred embodiment of the present invention;

FIG. 3 is a block diagram of a wireless phone computing platform in accordance with a preferred embodiment of the present invention;

FIG. 4 is a block diagram of a high level view of a system for transmitting and tendering electronic cash using phone wallets;

FIG. 5 is a flowchart depicting a method of transferring electronic cash;

FIGS. 6A-6C are menu displays depicting the options that may be presented to a customer for requesting a transaction from a phone wallet application; and

FIG. 7 is a flowchart depicting the processes of tendering cash using a phone wallet.

### DETAILED DESCRIPTION OF THE PREFERRED EMBODIMENT

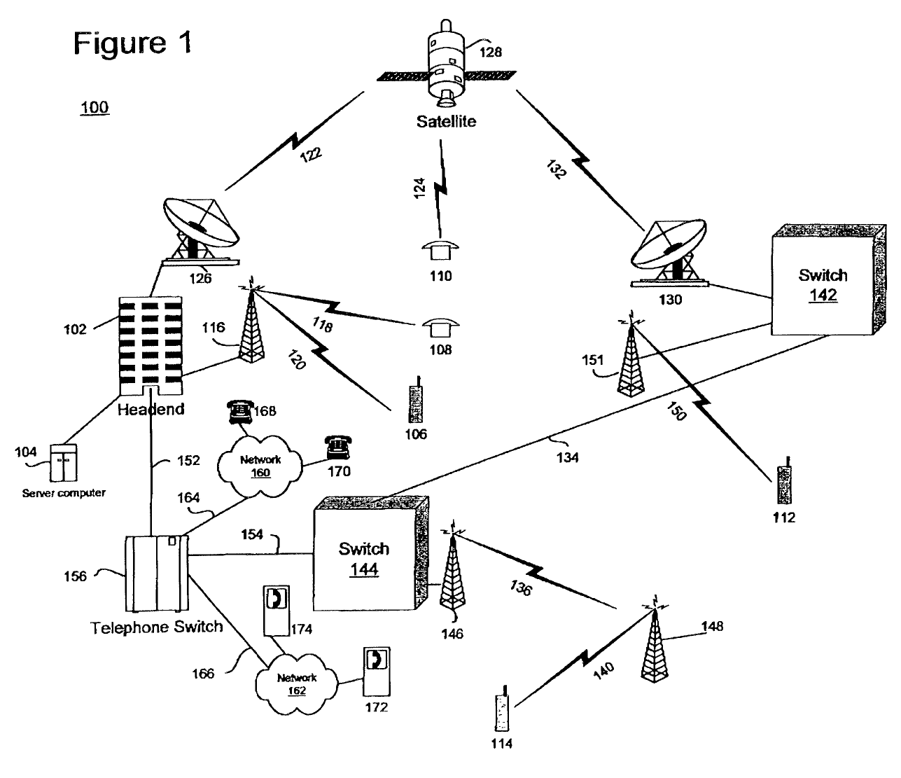

With reference now to the figures and in particular with reference to FIG. 1, a diagram of a computing system 100 is depicted in accordance with a preferred embodiment of the present invention. In this example, head-end 102 is connected to a server computer 104, which is employed to collect data from various phones that may be present within computing system 100. In particular, server computer 104 may communicate with various phone units 106-114 and 168-174. These phones may contain a computing platform that may communicate with server 104 as so-called “smart phones”. In this example, communications between various phone units may be accomplished through the standard telephone system, a cellular phone system, the Iridium198 satellite phone system, or other wireless systems.

Communication between server computer 104 and phone units 106-114 is accomplished in a number of different ways in this example. For example, radio tower 116 provides communications links 118 and 120 to phone units 108 and 106 respectively. Communications links 118 and 120 are radio frequency communications links generated between radio tower 116 and antennas located on phone units 106 and 108. Phone unit 108 may be a dual-use phone that may be used with both a satellite and cell-phone tower. In addition, server 104 may communicate with phone unit 110 through communications links 122 and 124. Communications link 122 is established between satellite dish 126 and satellite switch 128 with communications link 124 being established between satellite 128 and phone unit 110. Communications links 122 and 124 are radio frequency based links generated by signals sent to satellite switch 128 from satellite dish 126 and from satellite switch 128 to phone unit 110. In this example, radio tower 116 and satellite dish 126 are connected to head-end 102 and provide for transmissions originating from or passing through head-end 102.

Further, signals may be sent from satellite switch 128 to satellite dish 130 via communications link 132. From satellite dish 130, information may be sent to phone unit 114 through communications links 134, 136, and 140. Communications link 134 in this example is a link between switch 142 and switch 144. In this manner, a path may be established from server computer 104 to phone unit 114 to create a path containing communications links 122, 132, 134, 136, and 140. Communications link 134 is a physical link, which may be for example, coaxial cable, fiber optic cable, or a combination of the two. Each switch also has a “link”, also called a “path”, within the switch for routing data through the switch. An “input link” is the input or source portion of the link associated with the input into the switch, and an “output link” is the output or destination portion of the link associated with the output from the switch. Communications link 136 is established between radio towers 146 and 148. Radio tower 146 is connected to switch 144 in FIG. 1. Communications link 140 is established between radio tower 148 and phone unit 114. Communications with mobile unit 112 may be established through a path containing communications links 122, 132, and 150. Communications link 150 is established between radio tower 151 and phone unit 112. In this example, satellite dish 130 and radio tower 151 are connected to switch 142.

In addition, server computer 104 may use an alternate path to communicate with phone unit 114. For example, a path through communications links 152, 154, 136, and 140 may be employed to communicate with phone unit 114. Links 152 and 154 are physical links in this example. Communications link 152 is established between head-end 102 and switch 156, while communications link 154 is established between switch 156 and switch 144. In this manner, data signals, such as multi-media data, which may include video, graphics, voice, and text may be sent between server computer 104 and phone units 106-114. These data signals may also include GPS signal and navigation-type data.

In addition, computing system 100 also includes networks 160 and 162, which are in communication with server computer 104. Network 160 has a communications path to server computer 104 via communications links 164 and 152. Network 162 communicates with server computer 104 through communications links 166 and 152. Various phone facilities may be located within networks 160 and 162. For example, in FIG. 1, standard telephones 168 and 170 are located within network 160, while phone booths 172 and 174 are located within network 162. Of course, other facilities may be located within networks 160 or 162, such as PCs using Internet telephony.

Information may be obtained from phones 168-174 and sent to server computer 104. This information may include any information necessary for a navigation service to generate directions to or from these locations. Server 104 may poll networks 160 and 162 to obtain this information or the information may be pushed to server 104 from the networks.

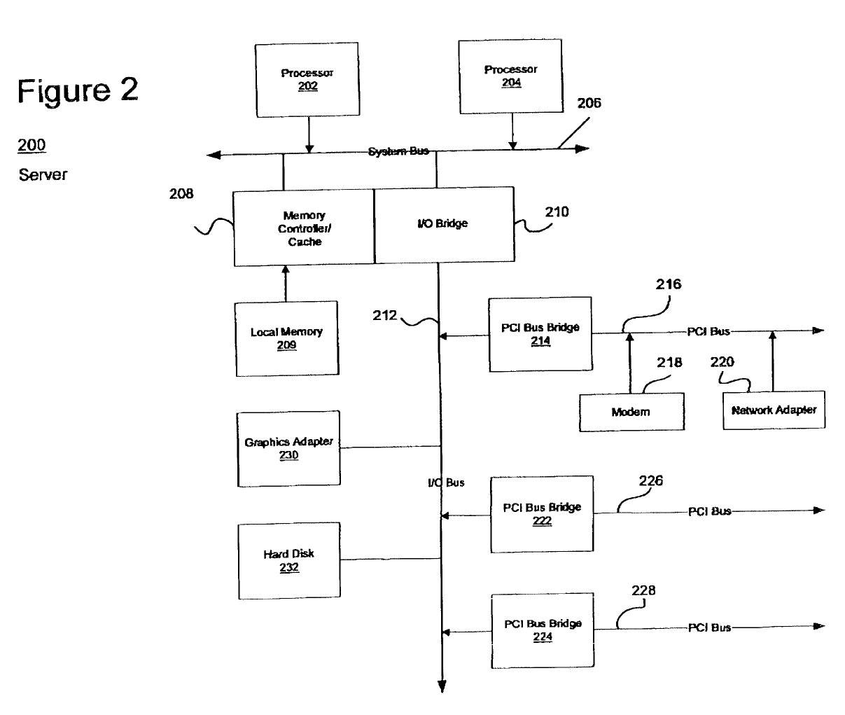

Referring to FIG. 2, a block diagram depicts a data processing system, which may be implemented as a server, such as server computer 104 in FIG. 1, in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to various mobile units illustrated in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as an optical disk drive and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

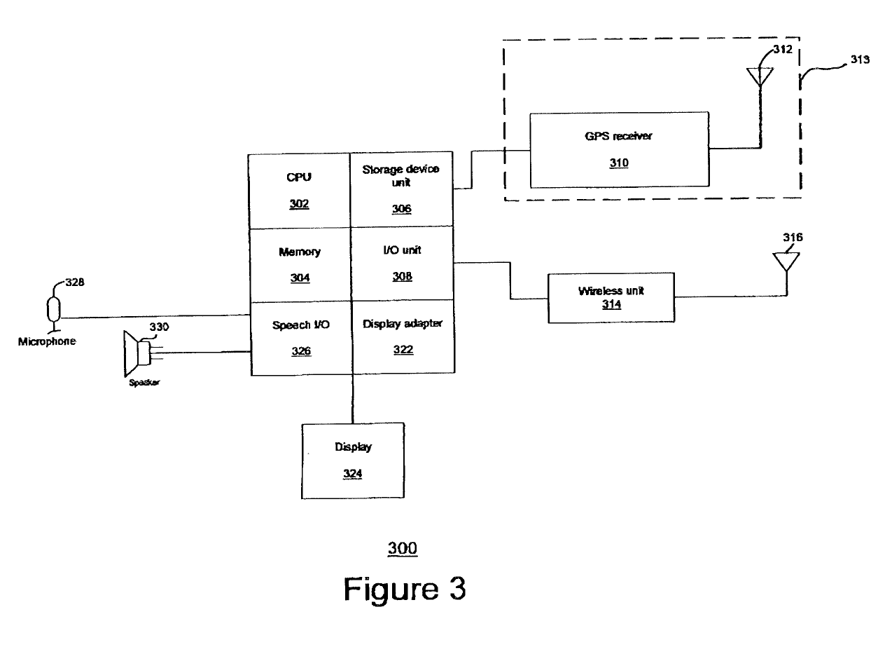

Turning next to FIG. 3, a block diagram of a wireless phone computing platform is depicted in accordance with a preferred embodiment of the present invention. Computing platform 300 is located within a cell phone, mobile phone, or satellite phone. Computing platform 300 includes a CPU 302, which may be an embedded processor or processor such as a Pentium processor from Intel Corporation. “Pentium” is a trademark of Intel Corporation. Computing platform 300 also includes memory 304, which may take the form of random access memory (RAM) and/or read only memory (ROM).

Computing platform 300 also contains a storage device unit 306. Storage device unit 306 may contain one or more portable storage devices, e.g., a hard disk drive, such as an IBM MicroDrive, or a flash memory card. Wireless phone computing platform 300 also includes an input/output (I/O) unit 308, which provides connections to various I/O devices. In this example, a GPS receiver 310 is optionally included, as denoted by dotted line 313, within wireless phone computing system 300 and receives signals through antenna 312. Wireless unit 314 provides for two-way communications between computing unit 300 and another data processing system, such as server 104 in FIG. 1, through antenna 316.

Computing unit 300 also includes a display adapter 322, which is connected to display 324. This display may be a touch screen display or an LCD display. Computing unit 300 also includes a microphone 328 and a speaker 330 which provide a user, in addition to standard voice communication, with an ability to enter commands and receive responses through speech I/O unit 326 without having to constantly divert attention to display 324.

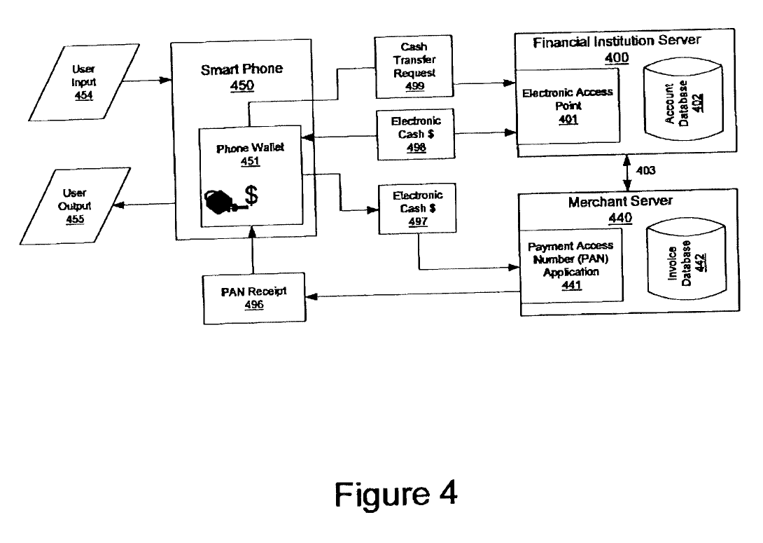

With reference now to FIG. 4, a block diagram provides a high level view of the method and apparatus for transmitting and tendering electronic cash using phone wallets. Financial institution server 400 provides computer resources for electronic transactions performed by a financial institution. The financial institution has account database 402 for storing account holder and customer information. The financial institution has also created electronic access point 401 on financial institution server 400 that allows account holders to access account information and perform financial transactions using various electronic means. Financial institution server 400 communicates with merchant server 440 through communication link 403. The financial institution and its merchant customers may transfer funds and other information about the electronic transactions, merchant accounts at the financial institution, or other various other financial matters. The merchant has invoice database 442 for tracking current and past purchases by the customers of the merchant. Other databases not shown may provide information resources for relationships between the merchants and supplier, etc. Merchant server 440 contains Payment Access Number (PAN) application 441 that provides a merchant with the capability to accept electronic cash from phone wallets according to the present invention. A Payment Access Number is a phone number that may be called by customer's to transfer electronic cash as payments for purchases. PAN application 441 monitors the PAN to receive all electronic cash transfers. Account holders of the financial institution and customers of the merchant may use smart phone 450 as a personal digital assistant (PDA) that communicates with financial institution server 400 and merchant server 440. Smart phone 450 contains smart wallet application 451 for managing electronic cash according to the present invention. Smart wallet 451 has been previously downloaded from the financial institution, configured at the financial institution by transferring smart wallet 451 by infrared transfer link to smart phone 450, or was preloaded onto smart phone 450 during its manufacture. Phone wallet 451 provides secure and encrypted communication for its transactions involving the transfer of electronic cash funds. Well known protocols, such as secure socket layers (SSL) or digital certificates may be used to ensure private and secure communications between smart phone 450 and other electronic systems.

Smart phone 450 receives user input 454 when a user of the smart phone must provide operating commands for the smart phone. Smart phone 450 also provides user output 455 when necessary, such as displaying menus to a user. Smart wallet 451 sends cash transfer request 499 to electronic access point 401 to perform electronic cash phone transactions. Electronic cash 498 is transmitted between phone wallet 451 and electronic access point 401 depending upon the withdrawal or deposit of the electronic cash at the financial institution. Phone wallet 451 sends electronic cash 497 to PAN application 441 on merchant server 440 when the customer using smart phone 450 desires to use electronic cash for a particular purchase of an item offered by the merchant. PAN application 441 responds to phone wallet 451 with PAN receipt 496 so that phone wallet 451 may be notified that purchase transactions have been completed or as a record of payment.

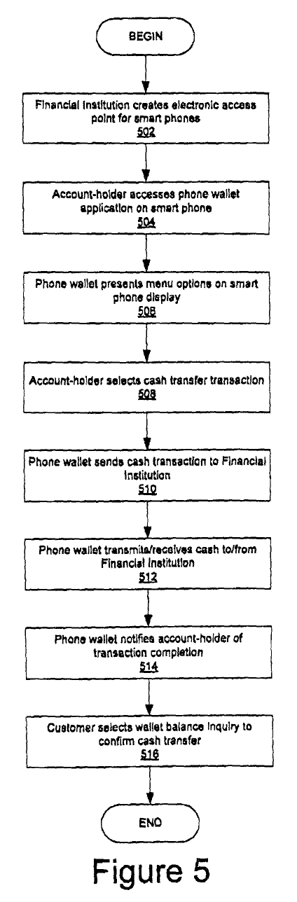

With reference now to FIG. 5, a flowchart depicts a method of transferring electronic cash. The process begins when the financial institution creates an electronic access point 401 for smart phones containing phone wallet technology (step 502). At some point in time, an account holder from the financial institution accesses phone wallet application 451 on smart phone 450 (step 504). The financial institution may have various security features to ensure proper and validated account access. For example, access to a particular account may be restricted to calls from particular phone numbers. The financial institution may use the caller ID feature of the phone system to verify that the proper phone is calling to access an account.

As a security feature, if the phone is lost, smart phone 450 may have several different types of security features to ensure that the electronic cash within the phone cannot be stolen. For example, phone wallet 451 may have a special override feature that deletes or invalidates all of the electronic cash on smart phone 450 when a special override code is sent to smart phone 450.

Phone wallet 451 presents menu options to the account holder using the display of the smart phone (step 506). The account holder may select a cash transfer transaction in order to perform some type of financial transaction with the financial institution (step 508). Phone wallet 451 sends cash transfer request 499 as a cash transaction to financial institution server 400 (step 510). Phone wallet 451 then transmits or receives electronic cash 498 to or from the financial institution depending upon whether the transaction is a deposit or withdrawal (step 512). Phone wallet 451 then notifies the account holder to the completion of the transaction (step 515). To do so, phone wallet 451 may display a dialog box requesting acknowledgment that the completion of a financial transaction was expected. The customer may then select the wallet balance inquiry function of phone wallet 451 to confirm that the cash transaction has been completed (step 516).

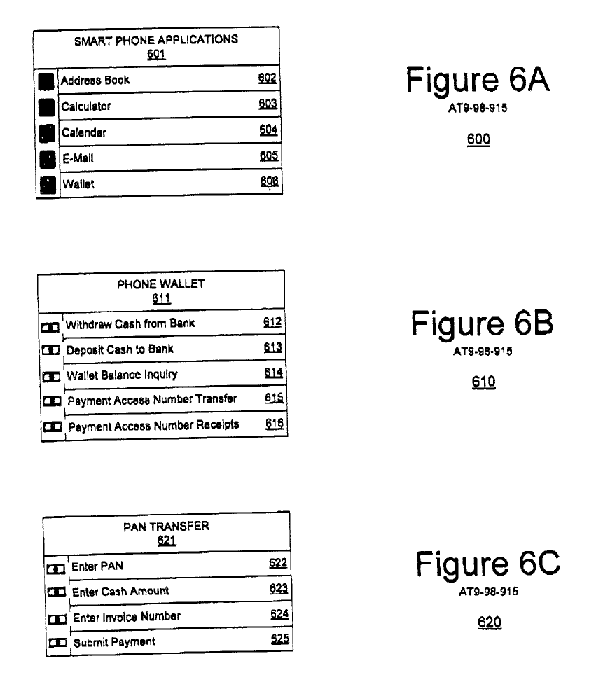

With reference now to FIGS. 6A-6C, menu displays depict the options that may be presented to a customer for requesting a transaction from the phone wallet application. In FIG. 6A, display 600 shows a menu 601 that contains applications that may be found on smart phone 450. Examples of applications include Address Book 602, Calculator 603, Calendar 604, E-mail application 605, and Wallet application 606. In FIG. 6B, display 610 shows menu 611 titled “Phone Wallet” and menu options for requesting transactions using phone wallet application 451. Menu option 612 allows an account holder to withdraw cash from a bank or other financial institution and store the electronic cash within phone wallet 451. Menu option 613 allows an account holder to deposit cash at a bank or other financial institution by withdrawing electronic cash from phone wallet 451. Menu option 614 allows a user to check the balance of the electronic cash stored within phone wallet 451. Menu option 615 allows a customer of the merchant to transfer electronic funds to the merchant's PAN when paying for a purchase. Menu option 616 allows a customer of the merchant to browse, edit, or delete receipts for purchases received when using the merchant's PAN or other electronic cash transactions involving payment access numbers. In FIG. 6C, display 620 shows menu 621 titled “PAN Transfer” and menu options 622-625. Menu option 622 allows a customer of the merchant to enter a PAN for transferring electronic cash to a merchant's PAN. Menu option 623 allows the customer to set the electronic cash amount to be transferred to the merchant. Menu option 624 allows the customer to enter his invoice number or purchase number that will be used by the merchant to reconcile the cash received in the transaction with the purchase. Menu option 625 allows the customer to submit payment for the goods or services being purchased from the merchant.

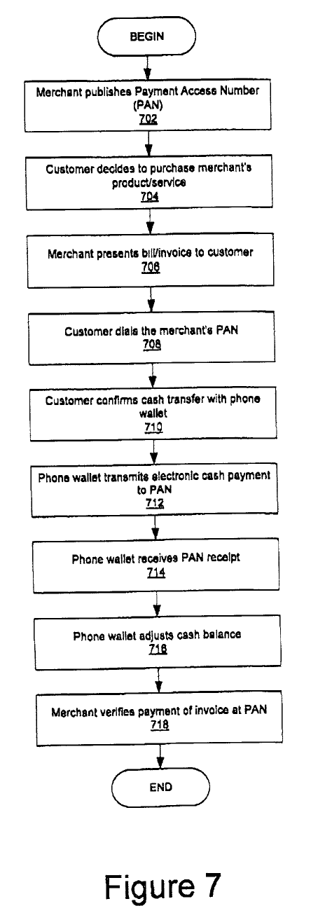

With reference now to FIG. 7, a flowchart depicts the processes of tendering cash using a phone wallet according to the present invention. At some point in time, the merchant has published a payment access number (PAN) in order to receive payment through electronic cash means (step 702). At some later point in time, the customer decides to purchase a product or service from the merchant (step 704). After the merchant has presented a bill or invoice to the customer (step 706), the customer dials the merchant PAN using smart phone 450. Once a connection is established between smart phone 450 and merchant server 440 through PAN application 441, phone wallet 451 may confirm the cash transfer transaction with the customer (step 710). Phone wallet 451 then transmits electronic cash 497 to PAN application 441. In return, phone wallet 451 receives PAN receipt 496 and stores the PAN within itself (step 714). Phone wallet 451 then adjusts the cash balance available on phone wallet 451 (step 716). The merchant may verify the payment of the invoice through PAN application 441.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a communications system for transferring cash, the method comprising:
sending cash in an electronic form to a phone using a wireless communications link, wherein the cash is electronic cash; and
storing the electronic cash in a memory within the phone.

2. The method of 1 further comprising transferring the electronic cash by calling a Payment Access Number.

3. The method of 2 further comprising matching the electronic cash received at the Payment Access Number as a payment for a purchase.

4. A method for processing an electronic transfer of funds in a distributed data processing system, the method comprising:
receiving a request for funds from a phone, wherein the request comprises a phone number; and
sending funds in electronic form to a phone identified by the phone number, wherein the funds are stored within the phone as electronic funds.

5. The method of claim 4 wherein the electronic cash request is received at a phone number of a financial institution.

6. The method of claim 5 wherein the financial institution restricts the electronic cash request to a set of registered phone numbers.

7. A data-processing-enabled phone:
receiving means for receiving electronic cash; and
redeeming means for redeeming the electronic cash.

8. The phone of claim 7 further comprising sending means for sending electronic cash by calling a Payment Access Number.

9. The phone of claim 8 wherein the Payment Access Number provides an ability to pay for a purchase recorded within a data processing system comprising the payment access number.

10. The phone of claim 7 further comprising disabling means for disabling the use of the electronic cash in the phone as a security feature.

11. A data processing system in a communications system for transferring cash, the data processing system comprising:
sending means for sending cash in an electronic form to a phone using a wireless communications link, wherein the cash is electronic cash; and
storing means for storing the electronic cash in a memory within the phone.

12. The data processing system of 11 further comprising transferring means for transferring the electronic cash by calling a Payment Access Number.

13. The data processing system of 12 further comprising reconciling means for reconciling the electronic cash received at the Payment Access Number as a payment for a purchase.

14. A data processing system for processing an electronic transfer of funds, the data processing system comprising:
receiving means for receiving a request for funds from a phone, wherein the request comprises a phone number; and
sending means for sending funds in electronic form to a phone identified by the phone number, wherein the funds are stored within the phone as electronic funds.

15. The data processing system of claim 14 wherein the electronic cash request is received at a phone number of a financial institution.

16. The data processing system of claim 15 wherein the financial institution restricts the electronic cash request to a set of registered phone numbers.

17. A computer program product in a computer readable medium for processing an electronic transfer of funds, the computer program product comprising:
first instructions for receiving a request for funds from a phone, wherein the request comprises a phone number; and
second instructions for sending funds in electronic form to a phone identified by the phone number, wherein the funds are stored within the phone as electronic funds.

18. A computer program product in a computer readable medium for use with a data-processing-enabled phone, the computer program product comprising:
first instructions for receiving electronic cash; and
second instructions for redeeming the electronic cash.
